(19) United States
(12) Patent Application Publication
(10) Pub. No.: US 2025/0317731 A1
(43) Pub. Date: Oct. 9, 2025

(54) ENHANCED KEYBOARD, VIDEO, AND MOUSE DONGLE

(71) Applicant: CenturyLink Intellectual Property LLC, Denver, CO (US)

(72) Inventor: Asghar HUSSAIN, McLean, VA (US)

(73) Assignee: CenturyLink Intellectual Property LLC, Denver, CO (US)

(21) Appl. No.: 19/092,897

(22) Filed: Mar. 27, 2025

Related U.S. Application Data
(60) Provisional application No. 63/631,916, filed on Apr. 9, 2024.

(51) Int. Cl. H04W 12/06; G06F 13/42

(52) U.S. Cl. CPC H04W 12/06; G06F 13/4282; G06F 2213/3814

(57) ABSTRACT

This disclosure describes wireless keyboard, video device, and mouse dongles with remote control capabilities. A keyboard, video display, and mouse (KVM) dongle device may include communication circuitry configured to receive wireless signals from at least one of a remote keyboard, a remote display, or a remote mouse; and processing circuitry configured to send commands, via at least one cable, to a device so that the device is remotely controlled by the remote keyboard, remote display, or remote mouse.

### CROSS-REFERENCE TO RELATED APPLICATIONS

This application claims the benefit of priority from U.S. Provisional Application Ser. No. 63/631,916, filed Apr. 9, 2024, which is incorporated herein by reference in its entirety

### TECHNICAL FIELD

Embodiments of the present disclosure generally relate to systems and devices using a keyboard, video, and mouse dongle.

### BACKGROUND

Keyboard, video, and mouse switches allow users to control multiple computers with a single keyboard, video display, and mouse. However, some devices are not meant to attach to a keyboard, video, or mouse, and connecting a keyboard, video, and mouse to them may involve significant wiring and a large physical footprint.

### SUMMARY

A keyboard, video display, and mouse (KVM) dongle device may include communication circuitry configured to receive wireless signals from at least one of a remote keyboard, a remote display, or a remote mouse; and processing circuitry configured to send commands, via at least one cable, to a device.

A keyboard, video display, and mouse (KVM) dongle device may include communication circuitry configured to receive wireless signals from at least one of a remote keyboard, a remote display, or a remote mouse; and processing circuitry configured to: authenticate a user of the at least one of the remote keyboard, the remote video display, or the remote mouse; and based on the authentication, send, via at least one cable, to a device, commands based on inputs received from the at least one of the remote keyboard, the remote video display, or the remote mouse.

A method for remotely controlling a device with a keyboard, video display, and mouse (KVM) dongle device, the method comprising: authenticating, by processing circuitry of a KVM dongle device, a user of at least one of a remote keyboard, a remote video display, or a remote mouse; based on the authentication, receiving, by communications circuitry of the KVM dongle device, inputs from the at least one of the remote keyboard, the remote video display, or the remote mouse; and sending, by the processing circuitry, via at least one cable connecting the KVM dongle device to a device, commands based on the inputs.

### BRIEF DESCRIPTION OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 shows an example system using a wireless keyboard, video, and mouse dongle, in accordance with one embodiment of the present disclosure;

FIG. 2 shows an example system using the wireless keyboard, video, and mouse dongle of FIG. 1, in accordance with one embodiment of the present disclosure;

FIG. 3 shows an example interface for authenticating a user to the wireless keyboard, video, and mouse dongle of FIG. 1, in accordance with one embodiment of the present disclosure;

FIG. 4 shows an example interface for monitoring and controlling devices with the wireless keyboard, video, and mouse dongle of FIG. 1, in accordance with one embodiment of the present disclosure;

FIG. 5 is flow for an example process for monitoring and controlling devices with the wireless keyboard, video, and mouse dongle of FIG. 1, in accordance with one embodiment of the present disclosure; and

FIG. 6 is a diagram illustrating an example of a computing system that may be used in implementing embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

Certain embodiments and principles will be discussed in more detail with reference to the figures. According to some embodiments, as discussed herein, aspects of the present disclosure involve systems and devices for using an enhanced keyboard, video, and mouse (KVM) dongle.

A KVM switch allows a user to connect one keyboard, video display, and/or mouse to multiple devices. The KVM switch may select which device to control at a particular time so that separate keyboards, displays, and mice are not needed for each device being controlled. However, connecting a keyboard, video display, and/or mouse to multiple devices may require the keyboard, video display, and/or mouse to be at the same physical location as the devices and may require significant wiring with a large physical footprint. For example, connecting a keyboard, video display, and/or mouse to multiple headless servers may be inconvenient in the above manner.

KVM switches are typically simple in hardware design, lacking wireless connectivity. As a result, the keyboard, video display, and/or mouse connecting to devices such as headless servers need to be proximal to the headless servers so that the keyboard, video display, and/or mouse may connect to the KVM switch that connects via wires to the devices.

Baseboard management controllers (BMCs) provide one technique for remotely monitoring and controlling devices, including network servers. However, BMCs are usually on a motherboard or main circuit board of the device being monitored, so to remotely monitor and control multiple devices with a single BMC requires connecting to software that interfaces with the BMC rather than connecting with a physical device connected to the device being controlled.

In one or more embodiments, an enhanced KVM dongle may connect to devices via wires and may connect wirelessly to a keyboard, video display, and/or mouse that may remotely control the devices via the wireless connection to the KVM dongle. For example, when the devices being controlled are servers, the KVM dongle may connect to the devices via a cable to a respective video port of the device being controlled and via a cable to a universal serial bus (USB) port of the device being controlled. The KVM dongle may include communications circuitry and processing circuitry. The communications circuitry may communicate wirelessly (e.g., using WiFi) to the keyboard, video display, and/or mouse (e.g., via an access point). In this manner, a keyboard, video display, and/or mouse may remotely connect to a wireless network (e.g., wireless local area network) provided by an access point connected to the KVM dongle. By connecting wirelessly to the KVM dongle connected to a device, the keyboard, video display, and/or mouse may remotely monitor and control the device connected to the KVM dongle.

In one or more embodiments, the processing circuitry of the KVM dongle may present pages to the remotely connected display to authenticate the user of the remote keyboard, video display, and/or mouse, and to allow the remote user to monitor and control the device connected to the KVM dongle. The processing circuitry also may facilitate security updates (e.g., for session border control, etc.) to control wireless communications with the KVM dongle. In this manner, the KVM dongle herein includes logic wireless communication hardware/capability than existing KVM switches, which are not used for wireless monitoring and control like the KVM dongle herein.

In one or more embodiments, the KVM dongle may be powered by its physical connection to a power supply and/or may include an optional battery for powering its hardware.

In one or more embodiments, inputs from the KVM devices to remotely control devices connected to the KVM dongle may be transmitted as wireless signals to the KVM dongle, and converted to commands for the connected devices. For example, when the connected device is a server, the commands may include global commands, resource commands, management commands, configuration commands, access control commands, commands to display server configuration information, commands to retrieve tasks available for the server, commands for servers to receive database updates, commands to gather and report security statistics for a server, and the like.

In this manner, the enhanced KVM dongle herein provides technical benefits of remotely connecting a keyboard, video display, and/or mouse to one or more devices for monitoring and control without the keyboard, video display, and/or mouse needing to be at the physical location of the device being monitored and controlled, and without needing to connect to software of a BMC.

The above descriptions are for purposes of illustration and are not meant to be limiting. Numerous other examples, configurations, processes, etc., may exist, some of which are described in greater detail below. Example embodiments will now be described with reference to the accompanying figures.

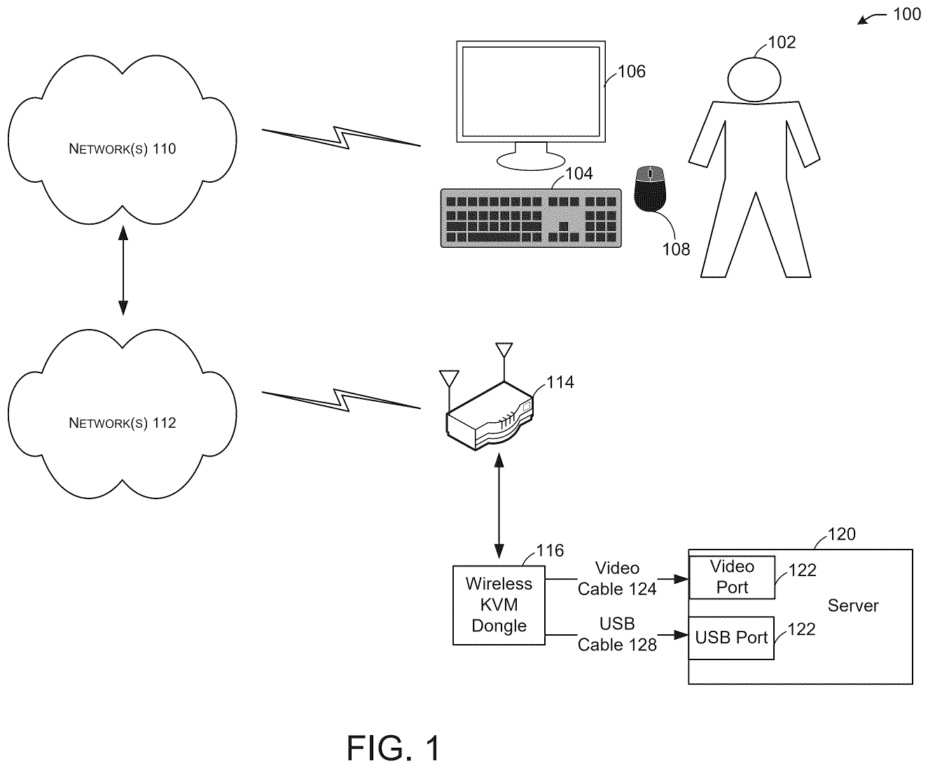

FIG. 1 shows an example system 100 using a wireless keyboard, video, and mouse dongle, in accordance with one embodiment.

Referring to FIG. 1, a user 102 of a keyboard 104, a video display 106, and a mouse 108 may use a network 110 to connect to a remote network 112 provided by an access point 114. A wireless KVM dongle 116 may connect to the network 112 via the access point 114, and may connect to a server 120 (e.g., a headless server). For example, the wireless KVM dongle 116 may connect to a video port 122 of the server 120 via a video cable 124 (e.g., HDMI, VGA, etc.). The wireless KVM dongle 116 may connect to a universal serial bus (USB) port 122 via a USB cable 128. Because of the wireless connection between the keyboard 104, the video display 106, and the mouse 108 to the wireless KVM dongle 116, the keyboard 104, the video display 106, and the mouse 108 may access the wireless KVM dongle 116. Because the wireless KVM dongle 116 may be connected to the server 120, the keyboard 104, the video display 106, and the mouse 108 may remotely monitor and/or control the server 120 via the wireless KVM dongle 116.

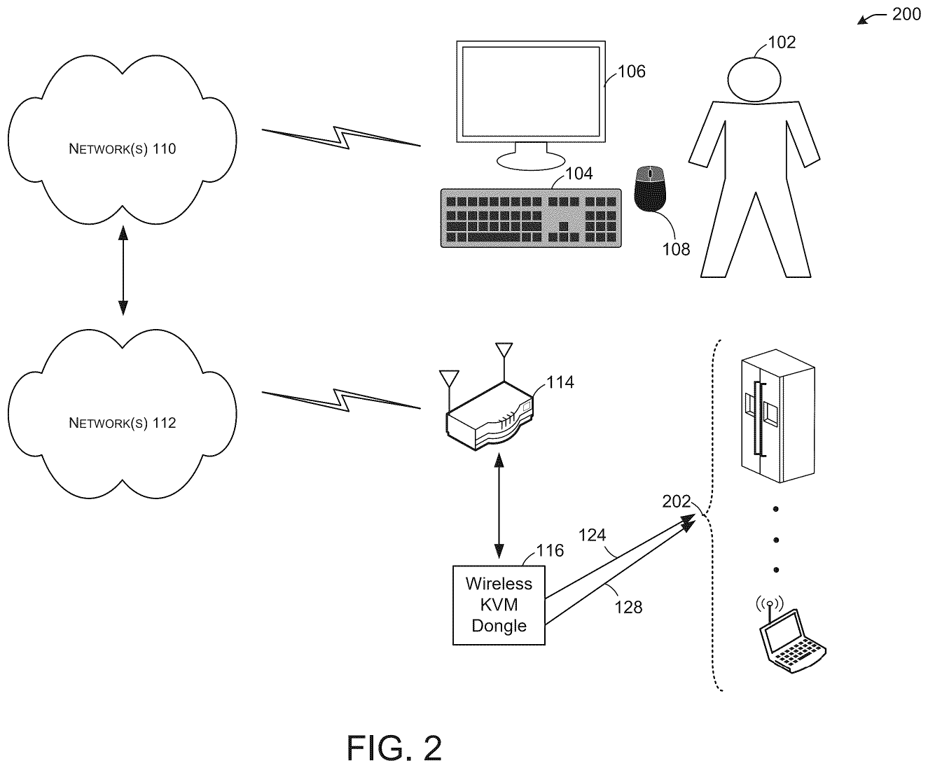

FIG. 2 shows an example system 200 using the wireless KVM dongle 116 of FIG. 1, in accordance with one embodiment.

Referring to FIG. 2, the user 102 of the keyboard 104, the video display 106, and the mouse 108 may use the network 110 to connect to the remote network 112 provided by the access point 114. The wireless KVM dongle 116 may connect to the network 112 via the access point 114, and may connect to one or more devices 202 (e.g., servers, user devices, etc.) via the video cable 124 and the USB cable 128. Because of the wireless connection between the keyboard 104, the video display 106, and the mouse 108 to the wireless KVM dongle 116, the keyboard 104, the video display 106, and the mouse 108 may access the wireless KVM dongle 116. Because the wireless KVM dongle 116 may be connected to the one or more devices 202, the keyboard 104, the video display 106, and the mouse 108 may remotely monitor and/or control the one or more devices 202 via the wireless KVM dongle 116.

Referring to FIGS. 1 and 2, the remote connection to the wireless KVM dongle 116 differs from a connection to a BMC for the server 120 or for the one or more devices 202. Rather than connecting to management software integrated with a BMC that is on-board hardware of the server 120 or the one or more devices 202, the keyboard 104, the video display 106, and the mouse 108 may connect to the server 120 and the one or more devices 202 via the wireless KVM dongle 116, which can send signals via the video cable 124 and/or the USB cable 128 without relying on the BMC management software.

In one or more embodiments, the network 110 and/or the network 112 may include, but are not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

In one or more embodiments, the access point 114 and the wireless KVM dongle 116 may include one or more communications antennas. The one or more communications antennas may be any suitable type of antennas corresponding to the communications protocols used by the access point 114 and the wireless KVM dongle 116. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the access point 114 and the wireless KVM dongle 116.

Any of the access point 114 and the wireless KVM dongle 116 may include any suitable radio and/or transceiver for transmitting and/or receiving radio frequency (RF) signals in the bandwidth and/or channels corresponding to the communications protocols utilized by any of the access point 114 and the wireless KVM dongle 116 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax), or 60 GHZ channels (e.g. 802.11ad, 802.11ay). 800 MHz channels (e.g. 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

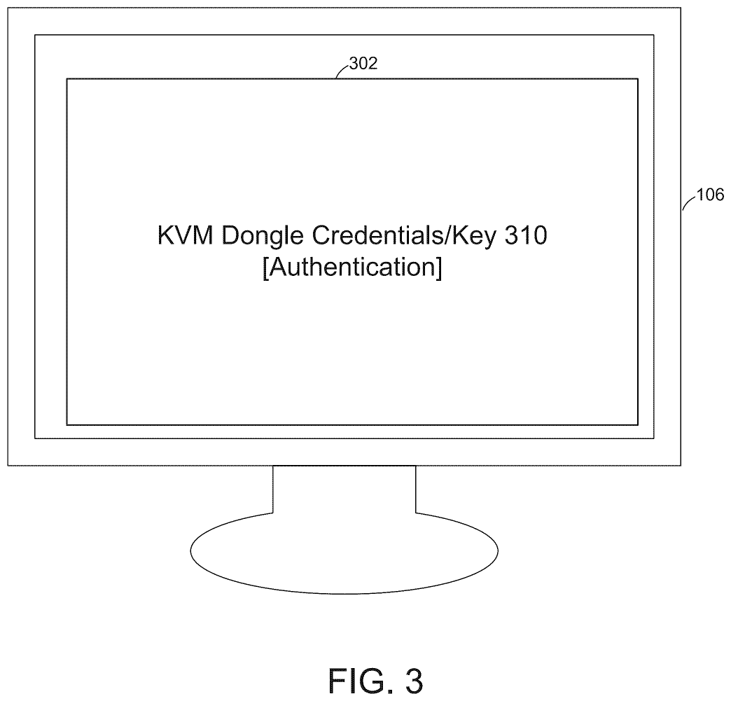

FIG. 3 shows an example interface 302 for authenticating a user to the wireless KVM dongle 116 of FIG. 1, in accordance with one embodiment.

Referring to FIG. 3, the video display 106, when connected to the server 120 or the one or more devices 202 of FIG. 2, may present one or more interfaces using one or more pages. For example, the interface 302 may allow the user 102 of FIG. 1 to authenticate to the wireless KVM dongle 116 via remote access (e.g., by entering login credentials or an encryption key 310). Once the user 102 has been authenticated to the wireless KVM dongle 116, the user 102 may control any device connected to the wireless KVM dongle 116 using interfaces presented via the video display 106.

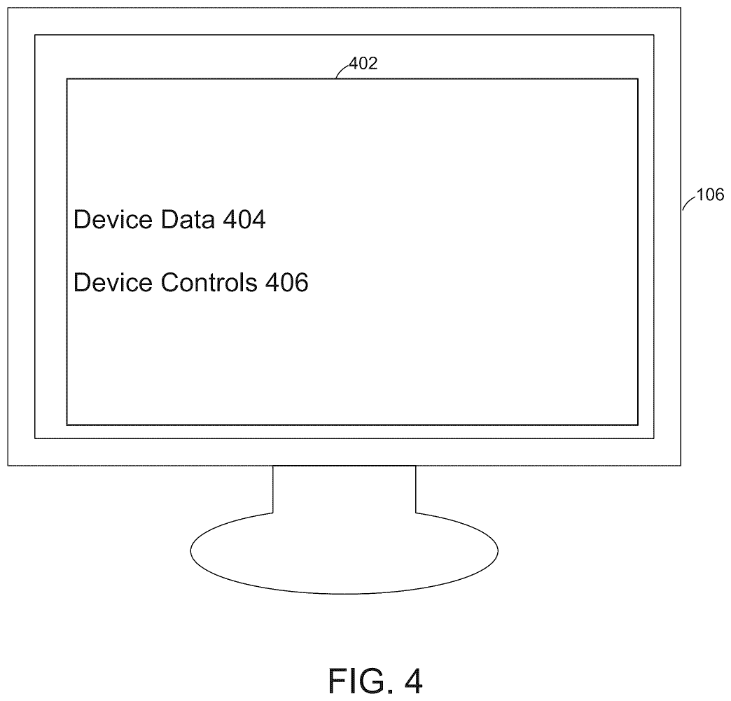

FIG. 4 shows an example interface 402 for monitoring and controlling devices with the wireless KVM dongle 116 of FIG. 1, in accordance with one embodiment.

Referring to FIG. 4, once the user 102 of FIG. 1 has authenticated to the wireless KVM dongle 116 (e.g., via the interface 302 of FIG. 3), the user 102 may view device data 404 and access device controls 406 to control operation of any device connected to the wireless KVM dongle 116 (e.g., the server 120 of FIG. 1 and/or the one or more devices 202 of FIG. 2). In this manner, the wireless KVM dongle 116 may present user interfaces that allow the user 102 to remotely monitor performance and control operations of the server 120 of FIG. 1 and/or the one or more devices 202 of FIG. 2. When the keyboard 104, the video display 106, and/or the mouse 108 of FIG. 1 provide user inputs (e.g., keystrokes, clicks, etc.), signals from the respective KVM devices may be translated into wireless commands to the wireless KVM dongle 116. When the wireless KVM dongle 116 receives commands from the KVM devices, the video cable 124 and/or the USB cable 128 of FIG. 1 may convert the commands into signals and send the signals to the server 120 of FIG. 1 and/or the one or more devices 202 of FIG. 2.

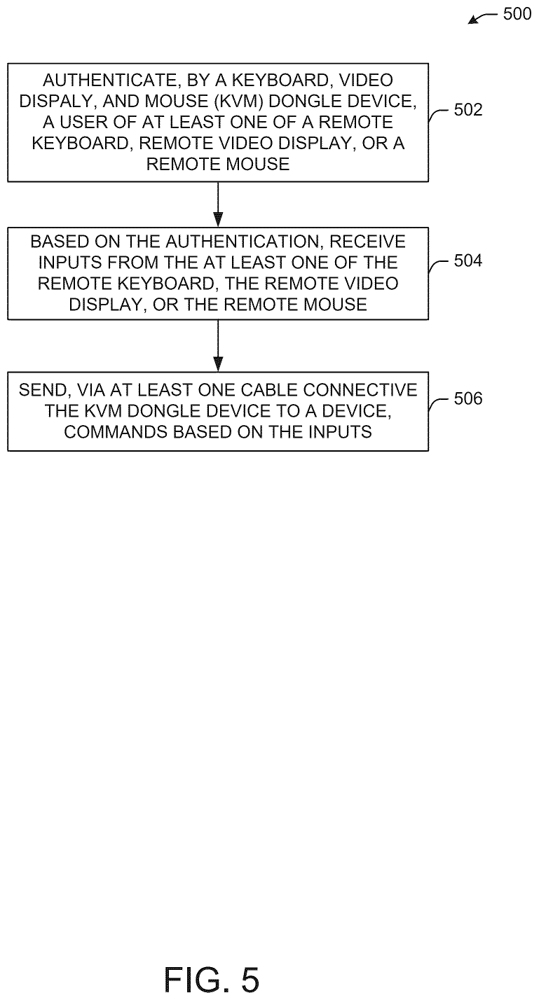

FIG. 5 is flow for an example process 500 for monitoring and controlling devices with the wireless keyboard, video, and mouse dongle of FIG. 1, in accordance with one embodiment.

At block 502, a KVM dongle device (e.g., the wireless KVM dongle 116 of FIG. 1) may authenticate (e.g., using the interface 302 of FIG. 3) a user of at least one of a keyboard, video display, or mouse (e.g., KVM devices).

At block 504, the KVM dongle device may, based on the user being authenticated, receive inputs from the at least one of the remote keyboard, the remote video display, or the remote mouse. The inputs may represent commands to control a device connected to the KVM dongle device. The remote keyboard, video display, and/or mouse may send wireless signals across a wireless network (e.g., via an access point providing a local area network to which the KVM dongle device may be connected). The KVM dongle device may receive the wireless signals representing the inputs, and may convert the wireless signals into commands. Alternatively, the wireless signals may include the commands.

At block 506, the KVM dongle device may control the connected device by sending signals (e.g., the commands) using one or more cables connecting the KVM dongle device to the controlled device (e.g., the server 120 of FIG. 1 or the one or more devices 202 of FIG. 2).

It is understood that the above descriptions are for purposes of illustration and are not meant to be limiting.

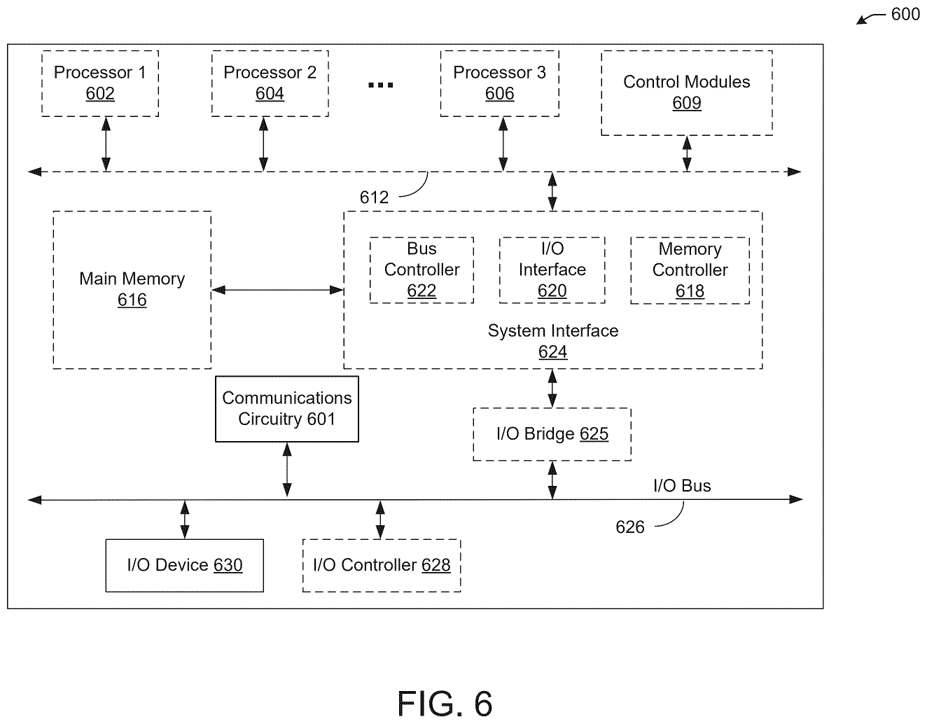

FIG. 6 is a block diagram illustrating an example of a computing device or computer system 600 which may be used in implementing the embodiments of the components of the network disclosed above. For example, the computing system 600 of FIG. 6 may represent the wireless KVM dongle 116 of FIG. 1.

The computer system 600 may include communications circuitry 601 for sending and receiving wireless signals, including wireless signals based on inputs sent from remote devices such as KVMs attempting to authenticate to the computer system 600 and to control devices connected to the computer system 600. The communications circuitry 601 may include circuitry that can operate the physical layer (PHY) communications and/or medium access control (MAC) communications for controlling access to the wireless medium, and/or any other communications layers for transmitting and receiving signals.

In accordance with some embodiments, the communications circuitry 601 may be arranged to contend for a wireless medium and configure frames or packets for communicating over the wireless medium. The communications circuitry 601 may be arranged to transmit and receive signals. The communications circuitry 601 may also include circuitry for modulation/demodulation, upconversion/downconversion, filtering, amplification, etc. In some embodiments, the communications circuitry 601 may include two or more antennas arranged for sending and receiving signals. The antennas may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

The computer system 600 (system) optionally may include one or more processors 602-606, and control modules 609 (e.g., hardware and/or software) capable of performing the process 500 of FIG. 5 as described herein. Processors 602-606 may include one or more internal levels of cache (not shown) and a bus controller 622 or bus interface unit to direct interaction with the processor bus 612. Processor bus 612, also known as the host bus or the front side bus, may be used to couple the processors 602-606 with the system interface 624. System interface 624 may be connected to the processor bus 612 to interface other components of the system 600 with the processor bus 612. For example, system interface 624 may include a memory controller 618 for interfacing a main memory 616 with the processor bus 612. The main memory 616 may include one or more memory cards and a control circuit (not shown). System interface 624 may also include an input/output (I/O) interface 620 to interface one or more I/O bridges 625 or I/O devices with the processor bus 612. One or more I/O controllers and/or I/O devices may be connected with the I/O bus 626, such as I/O controller 628 and I/O device 630, as illustrated.

I/O device 630 may also include an input device (not shown), such as an alphanumeric input device, including alphanumeric and other keys for communicating information and/or command selections to the processors 602-606. Another type of user input device includes cursor control, such as a mouse, a trackball, or cursor direction keys for communicating direction information and command selections to the processors 602-606 and for controlling cursor movement on the display device.

System 600 may include a dynamic storage device, referred to as main memory 616, or a random access memory (RAM) or other computer-readable devices coupled to the processor bus 612 for storing information and instructions to be executed by the processors 602-606. Main memory 616 also may be used for storing temporary variables or other intermediate information during execution of instructions by the processors 602-606. System 600 may include a read only memory (ROM) and/or other static storage device coupled to the processor bus 612 for storing static information and instructions for the processors 602-606. The system outlined in FIG. 6 is but one possible example of a computer system that may employ or be configured in accordance with aspects of the present disclosure.

According to one embodiment, the above techniques may be performed by computer system 600 in response to processor 604 executing one or more sequences of one or more instructions contained in main memory 616. These instructions may be read into main memory 616 from another machine-readable medium, such as a storage device. Execution of the sequences of instructions contained in main memory 616 may cause processors 602-606 to perform the process steps described herein. In alternative embodiments, circuitry may be used in place of or in combination with the software instructions. Thus, embodiments of the present disclosure may include both hardware and software components.

A machine readable medium includes any mechanism for storing or transmitting information in a form (e.g., software, processing application) readable by a machine (e.g., a computer). Such media may take the form of, but is not limited to, non-volatile media and volatile media and may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 606 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in main memory 616, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations together with all equivalents thereof.

What is claimed is:

1. A keyboard, video display, and mouse (KVM) dongle device, comprising:
communication circuitry configured to receive wireless signals from at least one of a remote keyboard, a remote display, or a remote mouse; and
processing circuitry configured to send commands, via at least one cable, to a device.

2. The KVM dongle device of claim 1, wherein the at least one cable comprises a video cable or a universal serial bus (USB) cable connecting the KVM dongle device to the device.

3. The KVM dongle device of claim 1, wherein the device is a headless server, and wherein the commands are control commands.

4. The KVM dongle device of claim 1, wherein the wireless signals are received from an access point device.

5. The KVM dongle device of claim 1, wherein the wireless signals are 802.11 WiFi signals.

6. The KVM dongle device of claim 1, wherein the processing circuitry is further configured to authenticate a user of the remote keyboard, the remote display, or the remote mouse.

7. The KVM dongle device of claim 1, wherein the processing circuitry is further configured to present one or more interfaces into which inputs from the remote keyboard, the remote display, or the remote mouse are received, and wherein the wireless signals are based on the inputs from the remote keyboard, the remote display, or the remote mouse.

8. A keyboard, video display, and mouse (KVM) dongle device, comprising:
communication circuitry configured to receive wireless signals from at least one of a remote keyboard, a remote video display, or a remote mouse; and
processing circuitry configured to:
authenticate a user of the at least one of the remote keyboard, the remote video display, or the remote mouse; and
based on the authentication, send, via at least one cable, to a device, commands based on inputs received from the at least one of the remote keyboard, the remote video display, or the remote mouse.

9. The KVM dongle device of claim 8, wherein the at least one cable comprises a video cable or a universal serial bus (USB) cable connecting the KVM dongle device to the device.

10. The KVM dongle device of claim 8, wherein the device is a headless server, and wherein the commands are control commands.

11. The KVM dongle device of claim 8, wherein the wireless signals are received from an access point device.

12. The KVM dongle device of claim 8, wherein the wireless signals are 802.11 WiFi signals.

13. A method comprising:
authenticating, by processing circuitry of a keyboard, video display, and mouse (KVM) dongle device, a user of at least one of a remote keyboard, a remote video display, or a remote mouse;
based on the authentication, receiving, by communications circuitry of the KVM dongle device, inputs from the at least one of the remote keyboard, the remote video display, or the remote mouse; and
sending, by the processing circuitry, via at least one cable connecting the KVM dongle device to a device, commands based on the inputs.

14. The method of claim 13, wherein the at least one cable comprises a video cable or a universal serial bus (USB) cable connecting the KVM dongle device to the device.

15. The method of claim 13, wherein the device is a headless server, and wherein the commands are control commands.

16. The method of claim 13, wherein the inputs are received from an access point device.

17. The method of claim 13, further comprising:
presenting, using the processing circuitry, a page associated with the authenticating.

18. The method of claim 13, further comprising:
presenting, using the processing circuitry, a page associated with receiving the inputs.

19. The method of claim 13, wherein the commands comprise server resource commands.

20. The method of claim 13, wherein the commands comprise global commands.
